(19) United States
(12) Patent Application Publication
(10) Pub. No.: US 2003/0121349 A1
(43) Pub. Date: Jul. 3, 2003

(54) Forward force producing system for wheels

(76) Inventor: Dug G. Lee, Los Angeles, CA (US)

Correspondence Address: PARK & SUTTON LLP, 3255 WILSHIRE BLVD, SUITE 1110, LOS ANGELES, CA, 90010, US

(21) Appl. No.: 09/804,120

(22) Filed: Mar. 13, 2001

(51) Int. Cl. G05G 1/00

(52) U.S. Cl. 74/469

(57) ABSTRACT

The present invention discloses a forward force producing system for wheels that generates a forward force using the downward force created by the weight of the load. The force from the weight of the vehicle and the vehicle load is transferred through the forward force producing system and creates a permanent forward force. The forward force provides an impetus to the forward motion of the wheel that serves, not only to counter act the effect of surface friction between the wheel and the surface, but also to propel the vehicle forward.

### BACKGROUND

This invention relates to a device for creating a forward force by the use of the weight of the vehicle to help the forward motion of wheels.

Many vehicles are designed for the carrying of heavy loads, including trains, trucks, cars, bicycles, dollies with casters and motorcycles. The weight of the vehicle and the load that is carried create a downward force, which increases the frictional forces between the wheels and the surface that the wheels rest upon. In order to overcome the frictional force and to propel the vehicle, a great force is required. It would be beneficial to have a system that could induce a forward force by the weight of the vehicle to help the forward propulsion of the vehicle, whether the forward propulsion is from a motor or other means of propulsion. And there is a great need for such a system to save not only the needed fossil fuel, but more importantly to improve the vehicle efficiency.

### SUMMARY

The present invention, a forward force producing system for wheels, fulfills the objective of a device that generates a forward force using the downward force created by the weight of the load. The force from the weight of the vehicle and the vehicle load is transferred through the forward force producing system and creates a forward force. The forward force provides an impetus to the forward motion of the wheel that serves, not only to counter act the effect of surface friction between the wheel and the surface, but also to propel the vehicle forward.

The forward force producing system for wheels includes a vehicle body having a rolling member and an axle attached to the rolling member. Bearings added to the rolling member assist in the rotation and reduce wear. The side plate has a first end, a second end and an extended portion located about the first end. An angled slot with an edge is located about the second end. The top of the extended portion connects to the vehicle body, so that, the weight of the vehicle and the load carried by the vehicle are exerted on the side plate.

A torque plate with a slide member is attached to the side plate between the extended portion and the second end. The secured end of the torque plate attaches to the slide member. The slide member is rotatably attached to the side plate. Opposite of the secured end is the movable end of the torque plate. A torque member is slidably attached about the movable end. The torque member has a free end positioned within the angled slot of the side plate. The angled slot allows limited movement of the free end. The limited movement is a sliding action of the torque member within the angled slot.

The torque plate accepts the axle. The torque plate can be attached to the wheel or can be the wheel.

The angled slot is an inventive aspect with the edge oriented to correspond to the direction of force being applied to the torque member. By angling the slot in this manner, all directional forces are canceled, except the forward force that is being exerted onto the torque member. This forward force is transferred to the wheel and the vehicle has a corresponding permanent-forward force exerted to it caused by the weight of the vehicle and the use of the invention.

The load of the vehicle body creates a downward force upon the extended portion of the side plate. The downward force is converted into a downward-angled force transferred through the slide member to the torque plate. Then the downward-angled force is applied to the point where the wheel touches the ground surface, and the downward-angled force is reflected back to the torque member. Because the torque member is equal distance apart from the force junction point as the slide member, and because of the angling of the angle slot, the upward force is canceled and only the forward force is maintained, inducing a forward motion on the wheel. This remaining forward force is used for the forward propulsion of the vehicle.

The side plate is attached to the vehicle so that the downward force created by the load is applied to the first end of the side plate. The distance from the vertical force line (shown as the centerline in the figures) of the extended portion to the slide member is equal or greater than half the distance between the slide member and the torque member. The slide member and the torque member are equal distance from an imaginary vertical line that intersects the force junction point.

### BRIEF DESCRIPTION OF THE DRAWINGS

With the above and additional objects and advantages in view, as will hereinafter appear, this invention comprises the devices, combinations and arrangements of parts hereinafter described, by way of example, and illustrated in the accompanying drawings of a preferred embodiment.

FIG. 1 is a side view of the present invention.

FIG. 2 illustrates an exploded bottom view showing the relationship of the torque plate to the side plate.

FIG. 3 illustrates an enlarged view of the angled slot and the associated forces.

### DETAILED DESCRIPTION OF THE DRAWINGS

Referring to FIGS. 1 through 3, the forward force producing system for wheels 10 includes a vehicle body 12 having a rolling member 14. The side plate 18 has a first end 20, a second end 22 and an extended portion 24 located about the first end 20. An angled slot 34 with an edge 36 is located about the second end 22. The rolling member 14 can be a wheel.

The extended portion 24 connects to the vehicle body 12, so that, the weight of the vehicle body 12 and the load carried by the vehicle body 12 are exerted on the side plate 18.

The torque plate 38 is located behind the side plate 18, with the lower portion of the torque plate 38 visible beneath the side plate 18. The torque plate 38 is the rolling member 14 in this embodiment. The secured end 42 of the torque plate 38 is slidably attached via the slide member 44 between the extended portion 24 and the second end 22 of the side plate 18. The slide member 44 can have a minimal rotation capability where the slide member 44 connects to the side plate 18. Opposite of the secured end 42 is the movable end 46 of the torque plate 38.

A torque member 48 is slidably attached to the side plate 18 about the movable end 46. The torque member 48 has a free end 50 positioned within the angled slot 34 of the side plate 18. The angled slot 34 allows limited movement of the free end 50. The angled slot 34 is angled to generally correspond to the line of force being applied to the torque member 48.

The angled slot 34 is an inventive aspect with the edge 36 oriented to correspond to the direction of force 56 being applied to the torque member 48. By angling the slot 34 in this manner, all directional forces are canceled by the fact that the torque member 48 is slidably attached to the angled slot 34, except the forward force 64 that is being exerted onto the torque member. This forward force 64 is transferred to the rolling member 14 and the vehicle 12 has a corresponding permanent-forward force 64 exerted to it caused by the weight of the vehicle 12 and the use of the invention, the forward force producing system for wheels 10. The angled slot of the side plate should at least five degrees from the vertical axis. The most preferred angle α of the angle slot is same as the angle α between the vertical axis 66 and the imaginary line 62 drawn between the center of the torque member 48 and the force junction point 61.

The load of the vehicle body creates a downward force 60 upon the extended portion 24 of the side plate 18. The downward force 60 is converted into a downward-angled force transferred through the slide member 44 to the torque plate 38. Then the downward-angled force is applied to the junction point 61 where the rolling member 14 touches the ground surface 67, and the downward-angled force is reflected back to the torque member 48. Because the torque member 48 is equal distance apart from the force junction point 61 to the surface as the slide member 44, and because of the angling of the angle slot 34, the upward force 62 is canceled and only the forward force 64 is maintained, inducing a forward motion on the wheel 14. This remaining forward force 64 is used for the forward propulsion 58 of the vehicle.

The torque plate 38 can be attached to the rolling member 14 or can be the rolling member 14 itself. The extended portion 24 of the side plate 18 can take various forms. FIG. 1 illustrates an “L” shaped side plate 18 with the extended portion 24 in a generally rectangular shape. However, the shape of the side place 18 is not limited to the shape shown.

The side plate 18 is attached to the vehicle 12 so that the downward force 60 created by the load is applied to the first end 20 of the side plate 18. The distance from the vertical force line 70 (shown as the centerline of the extended portion 24 in the figures) of the extended portion 24 to the slide member 44 is equal or greater than half the distance between the slide member 44, d3, and the torque member 48. The slide member 44 and the torque member 48 are equal distance, d1 and d2, from an imaginary vertical line that intersects the force junction point 61.

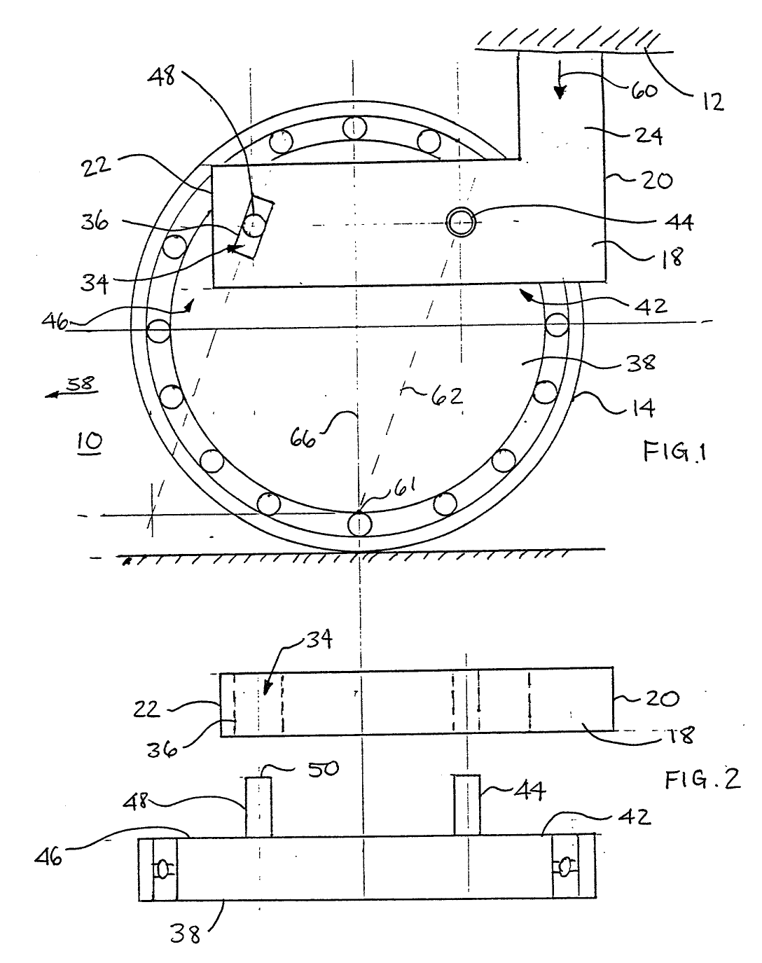

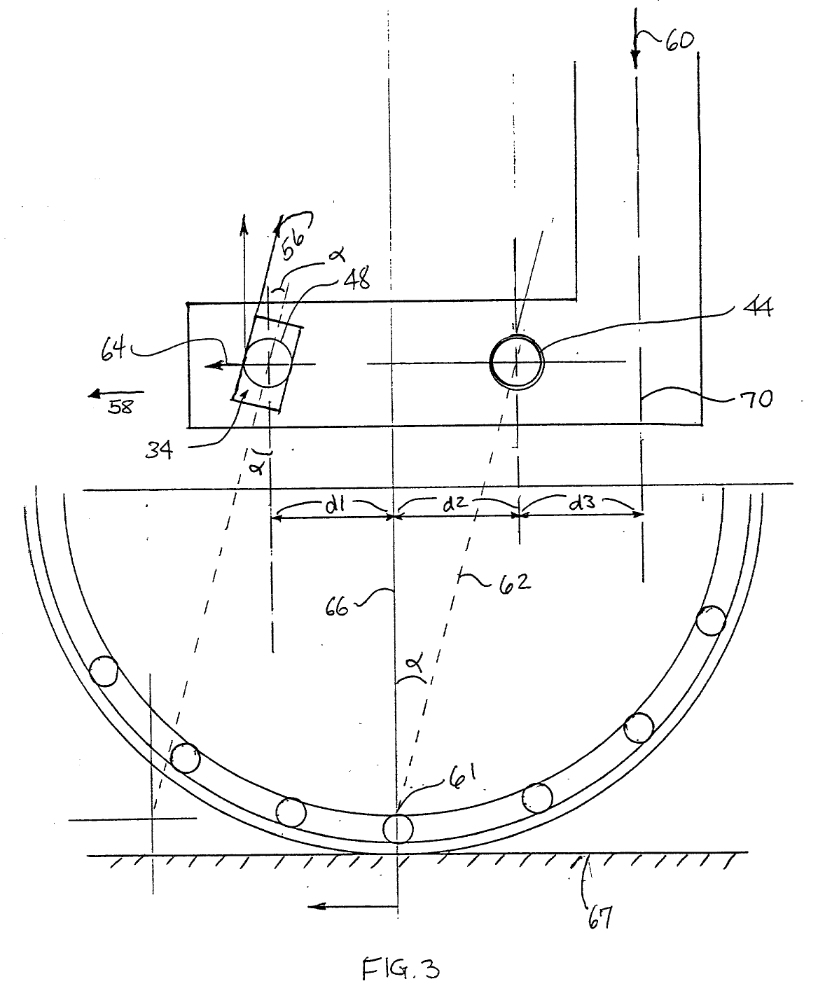

Referring to FIG. 2, an exploded bottom view of the invention is illustrated showing the positioning of the side plate 18 and torque plate 38 with the slide member 44 and torque member 48 between the torque plate 38 and the side plate 18. The slide member 44 connects between the side plate 18 and the torque plate 38. The slide member 44 slidably connects to the side plate 18 near the first end 20 and to the torque plate 38 near the secured end 42. The torque member 48 is slidably connected to the torque plate 38 about the movable end 46. The free end 50 of the torque member 48 is positioned within the angled slot 34. The torque member 48 has limited sliding movement within the angled slot 34.

While preferred embodiments of the invention have been described and illustrated for purposes of clarity and example, it should be understood that many changes, substitutions and modifications to the described embodiments will be apparent to those having skill in the art in light of the foregoing disclosure without departing from the scope and spirit of the present invention which is defined by the following claims.

What is claimed is:

1. A forward force producing system for wheels comprising:
a) a vehicle body having a rolling member;
b) a side plate having a first end, a second end, an extended portion located about the first end, and an angled slot having an edge located about the second end; wherein a load can be exerted on the extended portion; and
c) a torque plate having a slide member slidably attached to the side plate between the extended portion and the second end, a secured end attached to the slide member, a movable end, and a torque member slidably attached about the movable end; wherein the torque member having a free end positioned within the angled slot of the side plate; wherein the angled slot allows limited sliding movement of the free end.

2. The forward force producing system for wheels of claim 1 wherein the angled slot of the side plate is at least five degrees from the vertical axis.

3. The forward force producing system for wheels of claim 3 wherein the angled slot of the side plate is at least ten degrees from the vertical axis.

4. The forward force producing system for wheels of claim 3 wherein the angled slot of the side plate is at least twenty degrees from the vertical axis.

5. The forward force producing system for wheels of claim 1 wherein the angled slot of the side plate is at the same angle as the angle between a vertical axis and an imaginary line drawn between the center of the torque member and a force junction point.

6. The forward force producing system for wheels of claim 5 wherein the rolling member further having a bearing.

7. The forward force producing system for wheels of claim 6 wherein the rolling member is a wheel.

8. The forward force producing system for wheels of claim 7 wherein the torque plate is the wheel.

9. The forward force producing system for wheels of claim 8 wherein the torque member and the slide member are an equal distance from the imaginary vertical line that intersects the force junction point.
